(19) United States
(12) Patent Application Publication
(10) Pub. No.: US 2022/0312556 A1
(43) Pub. Date: Sep. 29, 2022

(54) INDUCTION HEATING CIRCUIT FOR INDUCTION HEATING COOKER

(71) Applicant: Gnics Co., Ltd., Bucheon-si, Gyeonggi-do (KR)

(72) Inventor: Min Ki LEE, Seoul (KR)

(73) Assignee: Gnics Co., Ltd., Bucheon-si, Gyeonggi-do (KR)

(21) Appl. No.: 17/685,347

(22) Filed: Mar. 2, 2022

(30) Foreign Application Priority Data
Mar. 11, 2021 (KR) 10-2021-0031799

(51) Int. Cl. H05B 6/06; H05B 6/12

(52) U.S. Cl. CPC H05B 6/065; H05B 6/1218; H05B 2213/05

(57) ABSTRACT

The present invention relates to an induction heating circuit for an induction heating cooker. The induction heating circuit for an induction heating cooker includes: one or more induction heating coils (111, 112 and 113) one or more resonance condensers (121, 122 and 123); one or more switching elements (Q1, Q2 and Q3); one or more switching drivers (131, 132 and 133); an on-time control unit (140); and a microcomputer (150) (=claim 1), whereby although the plurality of induction heating coils are provided on the single cooking tool, a configuration of the induction heating circuit can be simplified without any noise to thereby reduce the manufacturing cost can be reduced.

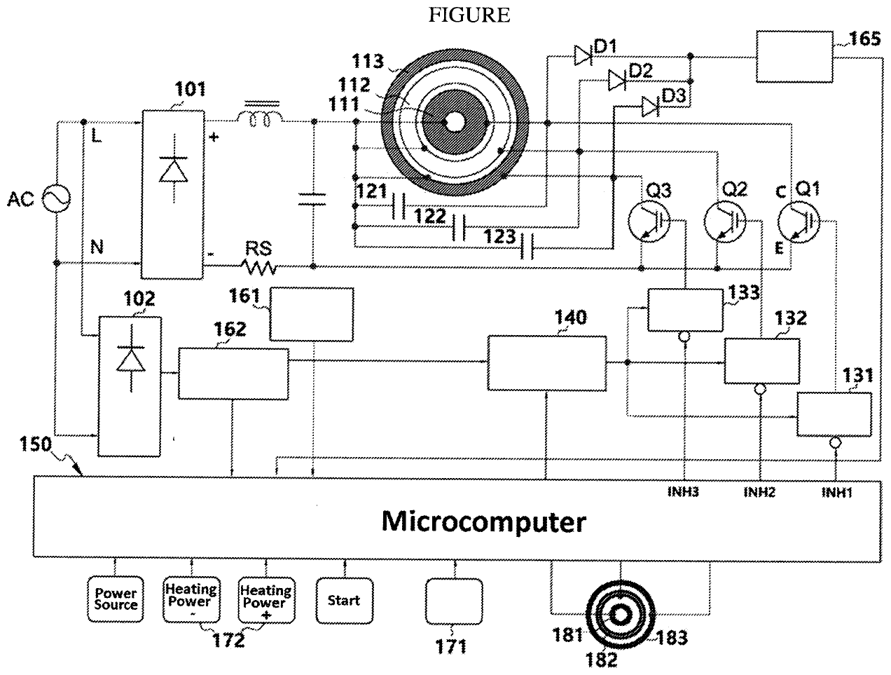

### CROSS-REFERENCE TO RELATED APPLICATIONS

This application claims the benefit of Korean Patent Application No. 10-2021-0031799, filed on Mar. 11, 2021 in the Korean Intellectual Property Office, which is incorporated herein by reference in its entirety.

### BACKGROUND OF THE INVENTION

### 1. Field of the Invention

The present invention relates to an induction heating cooker, and more particularly, to an induction heating circuit for an induction heating cooker configured such that although a plurality of induction heating coils is provided in a single cooking tool, a configuration of the induction heating circuit can be simplified without producing any noises to thereby reduce the manufacturing cost of the induction heating cooker.

### 2. Description of Related Art

In general, induction heating refers to a heating process which employs a phenomenon that when a primary inductive coil is coiled around a metal object to be heated to change a magnetic field, a secondary current (i.e., an induced current) flows through the surface of the metal object. When the induced current flows through the surface of the metal object, the metal object is heated up by heat generated due to its own resistance.

An example of electrical appliances that apply such an induction heating phenomenon is an induction heating cooker [e.g., an induction range].

The induction heating cooker is an electrical appliance which is configured to apply a voltage generated by rectifying commercial power and switching the rectified commercial power to an inductive coil to cause a strong magnetic field to be created within the inductive coil to heat a metal material, which is an object to be heated, through the magnetic field to cook a foodstuff in the cooker.

In addition, the induction heating cooker typically includes one induction heating coil per one cooking tool (i.e., induction burner).

In the meantime, a body to be heated (hereinafter, referred to as “to-be-heated body”) [e.g., a pot, a sauté pan, a frying pan, etc.] used as cookware may have a small, medium or large bottom size, and thus it has a variety of sizes.

If it is considered that a small-sized to-be-heated body employs a small induction heating coil, a medium-sized to-be-heated body employs a medium induction heating coil, and a large-sized to-be-heated body employs a large induction heating coil, this will be advantageous in terms of the thermal efficiency or uniform heating.

### PRIOR ART LITERATURE

### Patent Documents

Patent document 1: Korean Patent No. 10-2131357 (Issue date: Jul. 7, 2020)

Patent document 2: Korean Patent Laid-Open Publication No. 10-2016-0150512 (Laid-open date: Nov. 6, 2017)

### SUMMARY OF THE INVENTION

Accordingly, the present invention has been made to solve the aforementioned problems occurring in the prior art, and it is an object of the present invention to provide an induction heating circuit for an induction heating cooker in which although two or more induction heating coils provided at a single cooking tool (i.e., induction burner) are operated, generation of an induced noise due to a difference in the operating frequencies of the induction heating coils is fundamentally prevented so that even when the induction heating coil at the single cooking tool heats a to-be-heated body to cook a foodstuff, a quiet cooking environment without any noise can be provided and ultimately an induction range (i.e., induction heating cooker) without any beat noise caused by a resonance difference can be implemented.

Another object of the present invention is to provide an induction heating circuit for an induction heating cooker in which when a plurality of induction heating coils are installed at a single cooking tool, although a single output control means is adopted without the necessity of providing an inverter at each of induction heating coils, the plurality of induction heating coils can be operated so that the configuration of the induction heating circuits can be simplified to reduce the manufacturing cost of the product.

Still another object of the present invention is to provide an induction heating circuit for an induction heating cooker in which when a plurality of induction heating coils are installed at a single cooking tool, although a single output control means is adopted without the necessity of providing an inverter at each of induction heating coils, the plurality of induction heating coils can be operated so that the operation of the output control means can be relatively stabilized compared to the case where the inverter is provided at each of induction heating coils.

Yet another object of the present invention is to provide an induction heating circuit for an induction heating cooker in which a plurality of induction heating coils are provided at a single cooking tool in such a manner that only an induction heating coil corresponding to the size of a to-be-heated body is operated to increase the thermal efficiency and ensure the uniform heating, so that the cooking performance can be improved.

A further object of the present invention is to provide an induction heating circuit for an induction heating cooker in which the presence or absence of a to-be-heated body on a cooking burner can be detected and simultaneously the size of the to-be-heated body can be automatically detected, only the induction heating coil corresponding to the size of the detected to-be-heated body can be operated, so that the optimum efficient induction heating can be implemented conveniently.

A still further object of the present invention is to provide an induction heating circuit for an induction heating cooker in which the operation state of the concentrically arranged induction heating coils is displayed by a lamp (i.e., LED) having the same concentric circular image as that of the arrangement of the induction heating coils so that the operation state of a corresponding induction heating coil can be identified promptly and sensuously, so that the user utilization environment of the induction range can be improved.

A yet further object of the present invention is to provide an induction heating circuit for an induction heating cooker in which the operation of the induction heating coil exceeding the physical size of the to-be-heated body can be interrupted, so that safety accidents such as fire and the like can be prevented.

To achieve the above objects, the present invention provides an induction heating circuit for an induction heating cooker, including: one or more induction heating coils concentrically disposed on a single cooking tool of the induction heating cooker, and applied with a resonance current by the ON/OFF switching operation of switching elements to heat a to-be-heated body, the induction heating coils having the same inductance; one or more resonance condensers respectively correspondingly connected in parallel to the one or more induction heating coils in a one-to-one relation and having the same electrostatic capacity to perform a resonance action with the induction heating coils respectively corresponding to the resonance condensers; one or more switching elements respectively correspondingly connected to the induction heating coils and the resonance condensers in a one-to-one relation, and configured to interrupt the supply of current to the induction heating coils and the resonance condensers respectively correspondingly connected to each other in the one-to-one relation; one or more switching drivers respectively correspondingly connected to the one or more switching elements in a one-to-one relation, and configured to output a trigger signal for driving the switching elements in response to an on-time control signal; an on-time control unit configured to simultaneously output the on-time control signal therefrom to the one or more switching drivers in response to a power control signal to control the one or more switching elements to be driven simultaneously at the same on time; and a microcomputer configured to output the power control signal therefrom to the one-time control unit in response to a heating power adjustment input operation of a heating power adjustment unit, and output an operation interruption control signal for separately interrupting the operations of the one or more switching elements respectively correspondingly connected to the one or more switching drivers in the one-to-one relation to the switching drivers.

### Effects of the Invention

The induction heating circuit for an induction heating cooker of the present invention as constructed above has the following advantageous effects.

First, although two or more induction heating coils provided at a single cooking tool (i.e., induction burner) are operated, generation of an induced noise due to a difference in the operating frequencies of the induction heating coils is fundamentally prevented so that even when the induction heating coil at the single cooking tool heats a to-be-heated body to cook a foodstuff, a quiet cooking environment without any noise can be provided and ultimately an induction range (i.e., induction heating cooker) without any beat noise caused by a resonance difference can be implemented.

Second, when a plurality of induction heating coils are installed at a single cooking tool, although a single output control means is adopted without the necessity of providing an inverter at each of induction heating coils, the plurality of induction heating coils can be operated so that the configuration of the induction heating circuits can be simplified to reduce the manufacturing cost of the product.

Third, when a plurality of induction heating coils are installed at a single cooking tool, although a single output control means is adopted without the necessity of providing an inverter at each of induction heating coils, the plurality of induction heating coils can be operated so that the operation of the output control means can be relatively stabilized compared to the case where the inverter is provided at each of induction heating coils.

Fourth, a plurality of induction heating coils are provided at a single cooking tool in such a manner that only an induction heating coil corresponding to the size of a to-be-heated body is operated to increase the thermal efficiency and ensure the uniform heating, thereby improving the cooking performance.

Fifth, the presence or absence of a to-be-heated body on a cooking burner can be detected and simultaneously the size of the to-be-heated body can be automatically detected, only the induction heating coil corresponding to the size of the detected to-be-heated body can be operated, thereby implementing the optimum efficient induction heating conveniently.

Sixth, the operation state of the concentrically arranged induction heating coils is displayed by a lamp (i.e., LED) having the same concentric circular image as that of the arrangement of the induction heating coils so that the operation state of a corresponding induction heating coil can be identified promptly and sensuously, thereby improving the user utilization environment of the induction range.

Seventh, the operation of the induction heating coil exceeding the physical size of the to-be-heated body can be interrupted, thereby preventing safety accidents such as fire and the like.

### BRIEF DESCRIPTION OF THE DRAWINGS

The above and other objects, features and advantages of the present invention will be apparent from the following detailed description of the preferred embodiments of the invention when taken in conjunction with the accompanying drawings, in which:

The FIGURE is a block diagram showing an inner configuration of an induction heating circuit for an induction heating cooker according to an embodiment of the present invention.

### DESCRIPTION OF REFERENCE NUMERALS

101: first rectifying unit
102: second rectifying unit
111: inner induction heating coil
112: middle induction heating coil
113: outer induction heating coil
121: first resonant condenser
122: second resonant condenser
123: third resonant condenser
Q1: first switching element
Q2: second switching element
Q3: third switching element
131: first switching driver
132: second switching driver
133: third switching driver
140: on-time control unit
150: microcomputer
IN1,IN2,IN3: interruption terminal
RS: sensing resistor
161: input current sensing unit
162: input voltage and frequency sensing unit
D1,D2,D3: rectifier diode
165: resonance voltage sensing unit
171: coil selection unit
172: heating power adjustment unit
181: inner coil operation display lamp
182: middle coil operation display lamp
183: outer coil operation display lamp

### DETAILED DESCRIPTION OF THE PREFERRED EMBODIMENTS

Hereinafter, a preferred embodiment of an induction heating circuit for an induction heating cooker according to the present invention will be described in detail with reference to the accompanying drawing.

The induction heating circuit for an induction heating cooker according to an embodiment of the present invention includes: a plurality of induction heating coils 111, 112 and 113 applied with a rectified voltage having passed through a first rectifying unit 101 that converts alternating current power supplied from a commercial power source AC into direct current power, concentrically disposed on a single cooking tool [i.e., induction burner] (not shown) of the induction heating cooker, applied with a resonance current by the ON/OFF switching operation of switching elements Q1, Q2 and Q3 to heat a to-be-heated body (not shown), and having the same inductance (L1=L2=L3); a plurality of resonance condensers 121, 122 and 123 respectively correspondingly connected in parallel to the plurality of induction heating coils 111, 112 and 113 in a one-to-one relation, applied with the rectified voltage having passed through the first rectifying unit 101, and having the same electrostatic capacity (C1=C2=C3) to perform a resonance action by impedance matching with the induction heating coils 111, 112 and 113 respectively corresponding to the resonance condensers 121, 122 and 123 in the one-to-one relation; a plurality of switching elements Q1, Q2 and Q3 respectively correspondingly connected to the induction heating coils 111, 112 and 113 and the resonance condensers 121, 122 and 123 in a one-to-one relation, and configured to interrupt the supply of current to the induction heating coils 111, 112 and 113 and the resonance condensers 121, 122 and 123 respectively correspondingly connected to each other in the one-to-one relation; a plurality of switching drivers 131, 132 and 133 respectively correspondingly connected to the plurality of switching elements Q1, Q2 and Q3 in a one-to-one relation, and configured to output a trigger signal for driving the switching elements Q1, Q2 and Q3 in response to an on-time control signal; an on-time control unit 140 configured to determine the drive on time of the switching elements Q1, Q2 and Q3 in response to a power control signal and simultaneously output the on-time control signal therefrom to the plurality of switching drivers 131, 132 and 133 to control the plurality of switching elements Q1, Q2 and Q3 to be driven simultaneously at the same on time; and a microcomputer 150 configured to output the power control signal therefrom to the one-time control unit 140 in response to a heating power adjustment input operation of a heating power adjustment unit 172, and output an operation interruption control signal for separately interrupting the operations of the plurality of switching elements Q1, Q2 and Q3 respectively correspondingly connected to the plurality of switching drivers 131, 132 and 133 in the one-to-one relation to the switching drivers (131, 132 and 133).

In other words, the induction heating circuit for an induction heating cooker according to an embodiment of the present invention adopts a configuration in which although it includes the plurality of induction heating coils 111, 112 and 113, the on-time control unit 140 outputs only a single on-time control signal to simultaneously control the operations of the plurality of induction heating coils 111, 112 and 113 at the same on time and to separately disable the operations of the switching drivers.

By virtue of this configuration, the induction heating circuit for an induction heating cooker has an advantage in that a frequency of the on time and a resonance frequency of the off time coincides with each other to allow the operating frequencies applied respectively to the plurality of induction heating coils 111, 112 and 113 to coincide with each other, thereby fundamentally preventing generation of an induced noise due to a difference in the operating frequencies of the induction heating coils 111, 112 and 113.

In addition, instead of a configuration in which an output control means for controlling the output of the plurality of induction heating coils 111, 112 and 113 is provided in plural numbers to respectively correspond to the induction heating coils in a one-to-one relation, the induction heating circuit for an induction heating cooker has an advantage in that a configuration in which the on-time control unit 140 which is the output control means commonly connected to the plurality of switching elements Q1, Q2 and Q3 is provided and simultaneously interruption terminals INH1, INH2 and INH3 of the microcomputer 150 is used to separately disable the switching drivers 131, 132 and 133, so that the configuration of the induction heating circuits can be simplified to reduce the manufacturing cost of the product [i.e., when the plurality of induction heating coils are installed at a single cooking tool, the application of an inverter as an output control means to each of the induction heating coils results in an increase in the manufacturing cost of the product.], and the operation of the output control means can be relatively stabilized compared to the case where the output control means is provided in plural numbers.

In addition, a plurality of induction heating coils 111, 112 and 113 (two or more, preferably two to three induction heating coils) are provided at a single cooking tool in such a manner that only an induction heating coil corresponding to the size of a to-be-heated body (For example, a pot, a sauté pan, a frying pan, or the like) is operated to increase the thermal efficiency and ensure the uniform heating, thereby improving the cooking performance.

Further, in some embodiments, for example, the number of the induction heating coils 111 and 112 provided in the present invention may be two. In this case, an inner induction heating coil 111 and a middle induction heating coil 112, and a first resonance condenser 121 and a second resonance condenser 122 respectively correspondingly connected in parallel to the inner induction heating coil 111 and the middle induction heating coil 112 in a one-to-one relation are provided.

Specifically, the induction heating coils 111 and 112 include an inner induction heating coil 111 arranged in a circular shape on the innermost side thereof and a middle induction heating coil 112 arranged in a concentric shape so as to be spaced apart radially outwardly from the inner induction heating coil 111. The inner induction heating coil 111 and the middle induction heating coil 112 are configured such that the inductance L1 of the inner induction heating coil 111 and the inductance L2 of the middle induction heating coil 112 have the same inductance value (L1=L2) [for example, the inner and medium induction heating coils 111 and 112 are designed based on factors for determining inductance values such as thickness, length, etc., of the coil]. The resonance condensers 121 and 122 include: a first resonance condenser 121 connected in parallel to the inner induction heating coil 111, applied with the rectified voltage having passed through the first rectifying unit 101, and configured to perform a resonance action with the inner induction heating coil 111 by impedance matching; and a second resonance condenser 122 connected in parallel to the middle induction heating coil 112, applied with the rectified voltage having passed through the first rectifying unit 101, and configured to perform a resonance action with the middle induction heating coil 112 by impedance matching. The first resonance condenser 121 and the second resonance condenser 122 are configured such that the electrostatic capacity C1 of the first resonance condenser 121 and the electrostatic capacity C2 of the second resonance condenser 122 have the same electrostatic capacity value (C1=C2) [for example, the first and second resonance condenser 121 and 122 are designed as factors for determining dielectric constant, size, etc., of the condenser] to allow resonance frequencies to match each other.

The switching elements Q1 and Q2 include: a first switching element Q1 connected to the inner induction heating coil 111 and the first resonance condenser 121 that are connected in parallel to each other, and configured to interrupt the supply of current to the inner induction heating coil 111 and the first resonance condenser 121; and a second switching element Q2 connected to the inner induction heating coil 112 and the first resonance condenser 122 that are connected in parallel to each other, and configured to interrupt the supply of current to the inner induction heating coil 112 and the first resonance condenser 122.

The switching drivers 131 and 132 include: a first switching driver 131 connected to the first switching element Q1, and configured to output the trigger signal for driving the operation of the first switching element Q1 in response to the on-time control signal outputted from the on-time control unit 140, and a second switching driver 132 connected to the second switching element Q2, and configured to output the trigger signal for driving the operation of the second switching element Q2 in response to the on-time control signal outputted from the on-time control unit 140.

In addition, the number of the induction heating coils 111, 112 and 113 provided in the present invention may be three as shown in the FIGURE.

The induction heating coils 111, 112 and 113 include an inner induction heating coil 111 arranged in a circular shape on the innermost side thereof, a middle induction heating coil 112 arranged in a concentric shape so as to be spaced apart radially outwardly from the inner induction heating coil 111, and an outer induction heating coil 113 arranged in a concentric shape so as to be spaced apart radially outwardly from the middle induction heating coil 112. The inner induction heating coil 111, the middle induction heating coil 112 and the outer induction heating coil 113 are configured such that the inductance L1 of the inner induction heating coil 111, the inductance L2 of the middle induction heating coil 112, and the inductance L3 of the outer induction heating coil 113 have the same inductance value (L1=L2=L3) [for example, the inner, medium and outer induction heating coils 111, 112 and 113 are designed based on factors for determining inductance values such as thickness, length, etc., of the coil]. The resonance condensers 121, 122 and 123 include: a first resonance condenser 121 connected in parallel to the inner induction heating coil 111, applied with the rectified voltage having passed through the first rectifying unit 101, and configured to perform a resonance action with the inner induction heating coil 111 by impedance matching; a second resonance condenser 122 connected in parallel to the middle induction heating coil 112, applied with the rectified voltage having passed through the first rectifying unit 101, and configured to perform a resonance action with the middle induction heating coil 112 by impedance matching, and a third resonance condenser 123 connected in parallel to the outer induction heating coil 113, applied with the rectified voltage having passed through the first rectifying unit 101, and configured to perform a resonance action with the outer induction heating coil 113 by impedance matching. The first resonance condenser 121, the second resonance condenser 122, and the third resonance condenser 123 are configured such that the electrostatic capacity C1 of the first resonance condenser 121, the electrostatic capacity C2 of the second resonance condenser 122, and the electrostatic capacity C3 of the third resonance condenser 122 have the same electrostatic capacity value (C1=C2=C3) [for example, the first, second and third resonance condenser 121, 122 and 123 are designed based on factors for determining dielectric constant, size, etc., of the condenser] to allow resonance frequencies to match each other.

Similarly, the switching elements Q1, Q2 and Q3 include: a first switching element Q1 connected to the inner induction heating coil 111 and the first resonance condenser 121 that are connected in parallel to each other, and configured to interrupt the supply of current to the inner induction heating coil 111 and the first resonance condenser 121; a second switching element Q2 connected to the inner induction heating coil 112 and the first resonance condenser 122 that are connected in parallel to each other, and configured to interrupt the supply of current to the inner induction heating coil 112 and the first resonance condenser 122; and a third switching element Q3 connected to the outer induction heating coil 113 and the third resonance condenser 123 that are connected in parallel to each other, and configured to interrupt the supply of current to the outer induction heating coil 113 and the third resonance condenser 123.

Further, the switching drivers 131 and 132 include: a first switching driver 131 connected to the first switching element Q1, and configured to output the trigger signal for driving the operation of the first switching element Q1 in response to the on-time control signal outputted from the on-time control unit 140, a second switching driver 132 connected to the second switching element Q2, and configured to output the trigger signal for driving the operation of the second switching element Q2 in response to the on-time control signal outputted from the on-time control unit 140; and a third switching driver 133 connected to the third switching element Q3, and configured to output the trigger signal for driving the operation of the third switching element Q3 in response to the on-time control signal outputted from the on-time control unit 140.

In the meantime, of course, a configuration in which four induction heating coils [In this case, a fourth induction heating coil will be further arranged in a concentric shape so as to be spaced apart radially outwardly from the outer induction heating coil 113.] and four resonance condensers respectively correspondingly connected thereto are provided, falls within the technical scope of the present invention.

In the induction heating circuit for an induction heating cooker according to an embodiment of the present invention, each of the switching elements Q1, Q2 and Q3 includes: a collector terminal C connected to an associated one of the induction heating coils 111, 112 and 113, and an associated one of the resonance condensers 121, 122 and 123, which are correspondingly connected in parallel to each other in the one-to-one relation; an emitter terminal E connected to the first rectifying unit 101 at a power supply terminal; and a gate terminal G (i.e., an insulated gate bipolar transistor (IGBT)) connected to an associated one of the switching drivers 131, 132 and 133 corresponding to the switching elements Q1, Q2 and Q3 in a one-to-one relation.

In the induction heating circuit for an induction heating cooker according to an embodiment of the present invention, the microcomputer 150 includes a plurality of interruption terminals NH1, INH2 and INH3 correspondingly connected to the plurality of the switching drivers 131, 132 and 133 in a one-to-one relation, and the switching drivers 131, 132 and 133 receives the operation interruption control signal (e.g., logic signal HIGH) from the microcomputer 150 through the interruption terminals NH1, INH2 and INH3 to interrupt the output of the trigger signal outputted therefrom to the switching elements Q1, Q2 and Q3 connected thereto in a one-to-one relation.

In the case where three induction heating coils 111, 112 and 113 are provided in the present invention is three, the interruption terminals INH1, INH2 and INH3 include a first interruption terminal INH1 connected to the first switching driver 131 and configured to output the operation interruption control signal, a second interruption terminal INH2 connected to the second switching driver 132 and configured to output the operation interruption control signal, and a third interruption terminal INH3 connected to the switching driver 133 and configured to output the operation interruption control signal.

Hereinafter, a configuration will be described in which the size of a to-be-heated body is detected and at least one of the plurality of induction heating coils 111, 112 and 113 is selectively operated to supply an induction heating energy that is the most suitable to correspond to the detected size of the to-be-heated body.

In the induction heating circuit for an induction heating cooker according to an embodiment of the present invention, the microcomputer 150 detects whether or not the to-be-heated body is present at a region of the induction heating coils 111, 112 and 113 with the sequence running from the innermost to the outermost induction heating coils, controls only the induction heating coils 111, 112 and 113 where the to-be-heated body is detected to be operated, and outputs the operation interruption control signal if the to-be-heated body is not detected at the region of the induction heating coils 111, 112 and 113 to thereby interrupt the operation of induction heating coils 111, 112 and 113.

Specifically, the microcomputer 150 detects where or not the to-be-heated body is present at the region of the innermost induction heating coil [i.e., the inner induction heating coil 111 in the above embodiment], and then detects whether or not the to-be-heated body is present at the region of the adjacent induction heating coil [i.e., the middle induction heating coil 112 in the above embodiment] arranged spaced apart radially outwardly from the inner induction heating coil 111 if it is determined that the to-be-heated body is present at the region of the innermost induction heating coil.

Thereafter, if it is determined that the to-be-heated body is present at the region of the induction heating coil [i.e., the middle induction heating coil 112 in the above embodiment] adjacent to the inner induction heating coil 111, the microcomputer 150 detects whether or not the to-be-heated body is present at the region of the adjacent induction heating coil [i.e., the outer induction heating coil 113 in the above embodiment] arranged spaced apart radially outwardly from the middle induction heating coil 112.

The induction heating circuit for an induction heating cooker according to an embodiment of the present invention further includes: a sensing resistor RS connected in series between the first rectifying unit 101 and the induction heating coils 111, 112 and 113 to detect there is an input of an operating power; and an input current sensing unit 161 connected in parallel to a rear end of the sensing resistor RS to detect current flowing through the sensing resistor RS as a voltage value. The microcomputer 150 sequentially outputs the operation interruption control signal through the interruption terminal to interrupt the operation of the remaining induction heating coils except one of the induction heating coils 111, 112 and 113, which is to be operated, so as to sequentially operate only one induction heating coil [i.e., one of the inner induction heating coil, the middle induction heating coil, and the outer induction heating coil] with the sequence running from the innermost induction heating coil [i.e., the inner induction heating coil 111 in the above embodiment] to the outermost induction heating coil [i.e., the outer induction heating coil 113 in the above embodiment] of the plurality of induction heating coils 111, 112 and 113 (For example, the first interruption terminal INH1 is set to maintain a logic signal LOW and the remaining interruption terminals INH2 and INH3 are set to maintain a logic signal HIGH). The microcomputer 150 outputs a to-be-heated body detection control signal to the control unit 140 in a state where the operation interruption control signal has been outputted. The on-time control unit 140 generates the on-time control signal (for example, an extremely low energy signal of 4 to 5 us) for application to the switching drivers 131, 132 and 133 based on the to-be-heated body detection control signal applied thereto from the microcomputer 150. The microcomputer 150 reads the voltage value detected by the input current sensing unit 161, and determines that the to-be-heated body is present at the region where a corresponding induction heating coil is positioned if the detected voltage value is more than a preset to-be-heated body detection reference voltage value to normally operate the corresponding induction heating coil.

By virtue of this configuration, the microcomputer 150 detects the presence and absence of the to-be-heated body and automatically detects the size of the to-be-heated body so that only the induction heating coils 111, 112 and 113 suitable to correspond to the detected size of the to-be-heated body can be operated, resulting in the efficient induction heating.

The induction heating circuit for an induction heating cooker according to an embodiment of the present invention further includes a plurality of coil operation display units 181, 182 and 183 connected respectively correspondingly to the induction heating coils 111, 112 and 113 in the one-to-one relation and configured to display the operation state of the induction heating coils 111, 112 and 113, and the coil operation display units 181, 182 and 183 are displayed as concentric circular images respectively corresponding to the induction heating coils 111, 112 and 113 in the one-to-one relation.

As such, the operation state of the concentrically arranged induction heating coils 111, 112 and 113 is displayed as a concentric circular image so that the operation state of the induction heating coils 111, 112 and 113 can be identified promptly, thereby improving the user utilization environment.

The coil operation display units 181 and 182 include an inner coil operation display lamp 181 formed as a concentric circular image corresponding to the innermost induction heating coil [i.e., the inner induction heating coil 111 in the above embodiment] of the induction heating coils 111, 112 and 113 and configured to emit light when the innermost induction heating coil 111 is operated, and a middle coil operation display lamp 182 formed as a concentric circular image corresponding to the induction heating coil [i.e., the middle induction heating coil 112 in the above embodiment] concentrically outwardly adjacent to the inner induction heating coil 111 and configured to emit light when the middle induction heating coil 112 is operated.

Further, in some embodiments, The coil operation display units may further include an outer coil operation display lamp 183 formed as a concentric circular image corresponding to the induction heating coil [i.e., the outer induction heating coil 113 in the above embodiment] concentrically outwardly adjacent to the middle induction heating coil 112 and configured to emit light when the outer induction heating coil 113 is operated.

The induction heating circuit for an induction heating cooker according to an embodiment of the present invention further includes a coil selection unit 171 configured to select the operation or stoppage of the normally operated induction heating coils 111, 112 and 113 if it is determined that the to-be-heated body is present on the plurality of induction heating coils 111, 112 and 113.

In this case, although there is the normally operated induction heating coils 111, 112 and 113 by determining the presence of the to-be-heated body, the operation of the induction heating coils 111, 112 and 113 may be stopped depending on user needs.

For instance, in the case where the to-be-heated body has a medium size and the induction heating coils normally operated to correspond to the size of the to-be-heated body by the detection of the size of the to-be-heated body are, for example, the inner induction heating coil 111 and the middle induction heating coil 112, operation of at least any one of the inner induction heating coil 111 and the middle induction heating coil 112 can be stopped.

Although the above configuration is a configuration in which the size of the to-be-heated body is automatically detected to select an induction heating coil suitable for the detected size to operate the induction heating coil automatically, the user can select the induction heating coils depending on the needs that fit the utilization environment, thereby improving the user utilization environment.

In addition, the induction heating circuit for an induction heating cooker according to an embodiment of the present invention is characterized in that the coil selection unit 171 selects the induction heating coils 111, 112 and 113 which are not operated other than the normally operated induction heating coils 111, 112 and 113 normally operated by determining the presence of the to-be-heated body, the not-operated induction heating coils 111, 112 and 113 are not operated any more.

Thus, in the above embodiment, although the outer inductive heating coil 113 that is not operated by the detection of the size of the to-be-heated body is selected by the coil selection unit 171, it is not operated any more.

The reason for this is to interrupt the operation of the induction heating coil exceeding the size region of the to-be-heated body, thereby preventing safety accidents such as fire and the like.

Besides, in some embodiments, the induction heating circuit for an induction heating cooker of the present invention further includes a second rectifying unit 102 configured to rectify commercial power, and an input voltage and frequency sensing unit 162 configured to detect an input voltage and frequency rectified by the second rectifying unit 102. The microcomputer 150 reads the put voltage and frequency detected by the input voltage and frequency sensing unit 162.

In addition, in some embodiments, the induction heating circuit for an induction heating cooker of the present invention further includes a plurality of rectifier diodes D1, D2 and D3 whose anode (+) terminals are connected between the induction heating coils 111, 112 and 113 and the switching elements Q1, Q2 and Q3, and a resonance voltage sensing unit 165 connected to cathode (−) terminals of the rectifier diodes D1, D2 and D3 to detect a resonance voltage of each of the induction heating coils. The microcomputer 150 reads the resonance voltage detected by the resonance voltage sensing unit 165, and uses the switching elements Q1, Q2 and Q3 as triggers for switching on by a comparison the read resonance voltage with the input voltage value inputted through the input voltage and frequency sensing unit 162.

The induction heating circuit for an induction heating cooker of the present invention is characterized in that when at least one of the induction heating coils 111, 112 and 113 is operated, the resonance voltage sensing unit 165 can detect a resonance voltage thereof, and when the plurality of induction heating coils 111, 112 and 113 are operated, the resonance voltage sensing unit 165 can detect the highest voltage of the operated induction heating coils 111, 112 and 113.

While the specific exemplary embodiments according to the present invention have been described and illustrated with reference to the accompanying drawings, it will be obvious to those skilled in the art that the present invention can be carried out in other specific forms without changing the technical spirit or essential feature thereof. The presently disclosed embodiments are therefore considered in any respects to be illustrative but not restrictive.

The scope of the present invention should be construed to include the meaning and scope of the appended claims, and all the alterations and modified forms which are derived from the equivalent concept thereof, rather than the detailed description.

What is claimed is:

1. An induction heating circuit for an induction heating cooker, comprising:
one or more induction heating coils (111, 112 and 113) concentrically disposed on a single cooking tool of the induction heating cooker, and applied with a resonance current by the ON/OFF switching operation of switching elements (Q1, Q2 and Q3) to heat a to-be-heated body, the induction heating coils (111, 112 and 113) having the same inductance;
one or more resonance condensers (121, 122 and 123) respectively correspondingly connected in parallel to the one or more induction heating coils (111, 112 and 113) in a one-to-one relation and having the same electrostatic capacity to perform a resonance action with the induction heating coils (111, 112 and 113) respectively corresponding to the resonance condensers (121, 122 and 123);
one or more switching elements (Q1, Q2 and Q3) respectively correspondingly connected to the induction heating coils (111, 112 and 113) and the resonance condensers (121, 122 and 123) in a one-to-one relation, and configured to interrupt the supply of current to the induction heating coils (111, 112 and 113) and the resonance condensers (121, 122 and 123) respectively correspondingly connected to each other in the one-to-one relation;
one or more switching drivers (131, 132 and 133) respectively correspondingly connected to the one or more switching elements (Q1, Q2 and Q3) in a one-to-one relation, and configured to output a trigger signal for driving the switching elements (Q1, Q2 and Q3) in response to an on-time control signal;
an on-time control unit (140) configured to simultaneously output the on-time control signal therefrom to the one or more switching drivers (131, 132 and 133) in response to a power control signal to control the one or more switching elements (Q1, Q2 and Q3) to be driven simultaneously at the same on time; and
a microcomputer (150) configured to output the power control signal therefrom to the one-time control unit (140) in response to a heating power adjustment input operation of a heating power adjustment unit (172), and output an operation interruption control signal for separately interrupting the operations of the one or more switching elements (Q1, Q2 and Q3) respectively correspondingly connected to the one or more switching drivers (131, 132 and 133) in the one-to-one relation to the switching drivers (131, 132 and 133).

2. The induction heating circuit for an induction heating cooker according to claim 1, wherein each of the switching elements (Q1, Q2 and Q3) comprises: a collector terminal (C) connected to an associated one of the induction heating coils (111, 112 and 113), and an associated one of the resonance condensers (121, 122 and 123), which are correspondingly connected in parallel to each other in the one-to-one relation; an emitter terminal (E) connected to the first rectifying unit 101 at a power supply terminal; and a gate terminal (G) (i.e., an insulated gate bipolar transistor (IGBT)) connected to an associated one of the switching drivers (131, 132 and 133) corresponding to the switching elements (Q1, Q2 and Q3) in the one-to-one relation.

3. The induction heating circuit for an induction heating cooker according to claim 1, wherein the microcomputer (150) comprises one or more interruption terminals (NH1, INH2 and INH3) correspondingly connected to the one or more switching drivers 131, 132 and 133 in a one-to-one relation, and
wherein the switching drivers (131, 132 and 133) receives the operation interruption control signal from the microcomputer 150 through the interruption terminals (NH1, INH2 and INH3) to interrupt the output of the trigger signal outputted therefrom to the switching elements (Q1, Q2 and Q3) connected thereto in a one-to-one relation.

4. The induction heating circuit for an induction heating cooker according to claim 1, wherein the microcomputer (150) detects whether or not the to-be-heated body is present at a region of the induction heating coils (111, 112 and 113) with the sequence running from the innermost to the outermost induction heating coils, controls only the induction heating coils (111, 112 and 113) where the to-be-heated body is detected to be operated, and outputs the operation interruption control signal if the to-be-heated body is not detected at the region of the induction heating coils (111, 112 and 113) to thereby interrupt the operation of induction heating coils (111, 112 and 113).

5. The induction heating circuit for an induction heating cooker according to claim 4, further comprising:
a sensing resistor (RS) connected between the first rectifying unit (101) and the induction heating coils (111, 112 and 113); and
an input current sensing unit (161) connected in parallel to a rear end of the sensing resistor (RS) to detect current flowing through the sensing resistor (RS) as a voltage value,
wherein the microcomputer (150) sequentially outputs the operation interruption control signal so as to sequentially operate only one induction heating coil with the sequence running from the innermost induction heating coil (111) to the outermost induction heating coil (113) of the induction heating coils (111, 112 and 113), and outputs a to-be-heated body detection control signal to the control unit (140) in a state where the operation interruption control signal has been outputted,
wherein the on-time control unit (140) generates the on-time control signal for application to the switching drivers (131, 132 and 133) based on the to-be-heated body detection control signal applied thereto from the microcomputer (150), and
wherein the microcomputer (150) reads the voltage value detected by the input current sensing unit (161), and determines that the to-be-heated body is present at the region where a corresponding induction heating coil (111, 112 and 113) is positioned to normally operate the corresponding induction heating coil (111, 112 and 113) if the detected voltage value is more than a preset to-be-heated body detection reference voltage value.

6. The induction heating circuit for an induction heating cooker according to claim 5, further comprising one or more coil operation display units (181, 182 and 183) connected respectively correspondingly to the induction heating coils (111, 112 and 113) in the one-to-one relation and configured to display the operation state of the induction heating coils (111, 112 and 113), and
wherein the coil operation display units (181, 182 and 183) are displayed as concentric circular images respectively corresponding to the induction heating coils (111, 112 and 113) in the one-to-one relation.
